(19) United States
(12) Patent Application Publication
(10) Pub. No.: US 2013/0132380 A1
(43) Pub. Date: May 23, 2013

(54) APPLYING EFFECTS TO ELECTRONIC MEDIA FILES

(71) Applicant: Tony Polichroniadis, Bromley (GB)

(72) Inventor: Tony Polichroniadis, Bromley (GB)

(73) Assignee: Anthropics Technology Limited, London (GB)

(21) Appl. No.: 13/700,203

(22) PCT Filed: May 26, 2011
(86) PCT No.: PCT/EP11/58692

§ 371 Date: Feb. 6, 2013

(30) Foreign Application Priority Data
May 27, 2010 (GB) 1008924.1

(51) Int. Cl. G06F 17/30

(52) U.S. Cl. CPC G06F 17/30023
USPC 707/723; 707/769

(57) ABSTRACT

A method of searching for an effect to apply to an electronic media file, fee method comprising: storing a plurality of effects, each effect having one or more identifiers associated with it; receiving a search query which defines one or more search terms having one or more corresponding identifiers; retrieving a set of effects which are associated with the one or more identifiers; and outputting a set of search results comprising the set of retrieved effects, each applied to the electronic media file.

### FIELD

The present invention relates to applying an effect to an electronic media file such as applying image effects to a digital image file.

### BACKGROUND

Improving the content of electronic media files such as improving photographs or image editing, in general, is a difficult task for the untrained. This is because, to date, image editing has always been approached by providing a set of tools which change images in particular ways. Software such as Adobe Photoshop advances in each version by further adding to the set of tools available, which while making it more powerful, also increases the complexity of the software. Typically, because in order to produce effects, several tools must be used in conjunction with each other, the complexity grows much faster than the number of tools. Using help files that come with the software is rarely helpful for many tasks, as they cannot cover the breadth of changes someone might want to achieve.

To date, the best approach to dealing with this complexity has emerged not in a single system, but instead as an ad hoc approach users apply to deal with the problem. If users want to achieve something they do not know how to do yet, they can use a search engine such as Google to find a tutorial on the internet telling them how to achieve it. This approach is slow, error prone, and the user will not know how the effect will look when applied to their own image until the end of the process. Additionally, search engines have no knowledge about how well a tutorial is likely to work on a given image; instead the search engine uses the popularity of a page as an indication of how well the tutorial is likely to work. This ends up with tutorials frequently failing on images. Finally, once one gets to the end of tutorial, there is no way to go back and adjust one of the prior stages in the tutorial, not just for technical reasons, but simply because the user is unlikely to know which parts of the tutorial are amenable for adjustment.

The present invention seeks to provide an improved way of applying effects to the content of electronic media files such as digital images.

### SUMMARY

According to an aspect of the present invention, there is provided a method of searching for an effect to apply to an electronic media file. The method comprises: storing a plurality of effects, each effect having one or more identifiers associated with it; receiving a search query which defines one or more search terms having one or more corresponding identifiers; retrieving a set of effects which are associated with the one or more identifiers; and outputting a set of search results comprising the set of retrieved effects, each applied to the electronic media file.

By storing a plurality of effects having associated identifiers, a user can search for appropriate effects, which are then applied to the content of the user's electronic file for the user to consider before selecting a preferred one or more of the effects. Accordingly, the approach does not suffer from the problems set out above and a more efficient way of applying an effect to the content of an electronic media file is provided. Furthermore, as more and more effects can be added, for example by a community of users, embodiments of the present invention can provide a large, ready-made, body of effects for users to draw upon.

Another aspect of the present invention provides a system comprising a memory and a processor, wherein the processor is arranged to perform the above method.

Another aspect of the present invention provides a computer-readable medium having computer-executable instructions adapted to cause a computer system to perform the above method.

Other aspects and features of the present invention will be appreciated from the following description and the accompanying claims.

### BRIEF DESCRIPTION OF THE DRAWINGS

Embodiments of the present invention will now be described, by way of example only, with reference to the accompanying drawings in which like reference numerals are used to depict like parts. In the drawings:

FIG. 1 depicts a networked architecture;

FIGS. 2 and 3 illustrate a plurality of effects or library of effects, each associated with one or more identifiers;

FIG. 4 illustrates an interface for searching, and some example search results;

FIG. 5 is a flow diagram showing the steps of an embodiment of the invention;

FIG. 6 illustrates another interface for searching;

FIGS. 7 and 8 illustrates another library of effects;

FIG. 9 illustrates a dictionary; and

FIGS. 10 and 11 illustrate scores for identifier and effect combinations.

### DETAILED DESCRIPTION

Embodiments of the present invention relate to searching on a computer system for effects to be applied to the content of an electronic media file.

A system or computer such as a general-purpose computer which is configured or adapted to perform the described methods. In one embodiment the system (not shown) comprises a processor, memory, and a display. Typically, these are connected to a central bus structure, the display being connected via a display adapter. The system can also comprise one or more input devices (such as a mouse and/or keyboard) and/or a communications adapter for connecting the computer to other computers or networks. These are also typically connected to the central bus structure, the input device being connected via an input device adapter. In operation the processor can execute computer-executable instructions held in the memory and the results of the processing are displayed to a user on the display. User inputs for controlling the operation of the computer may be received via input device(s).

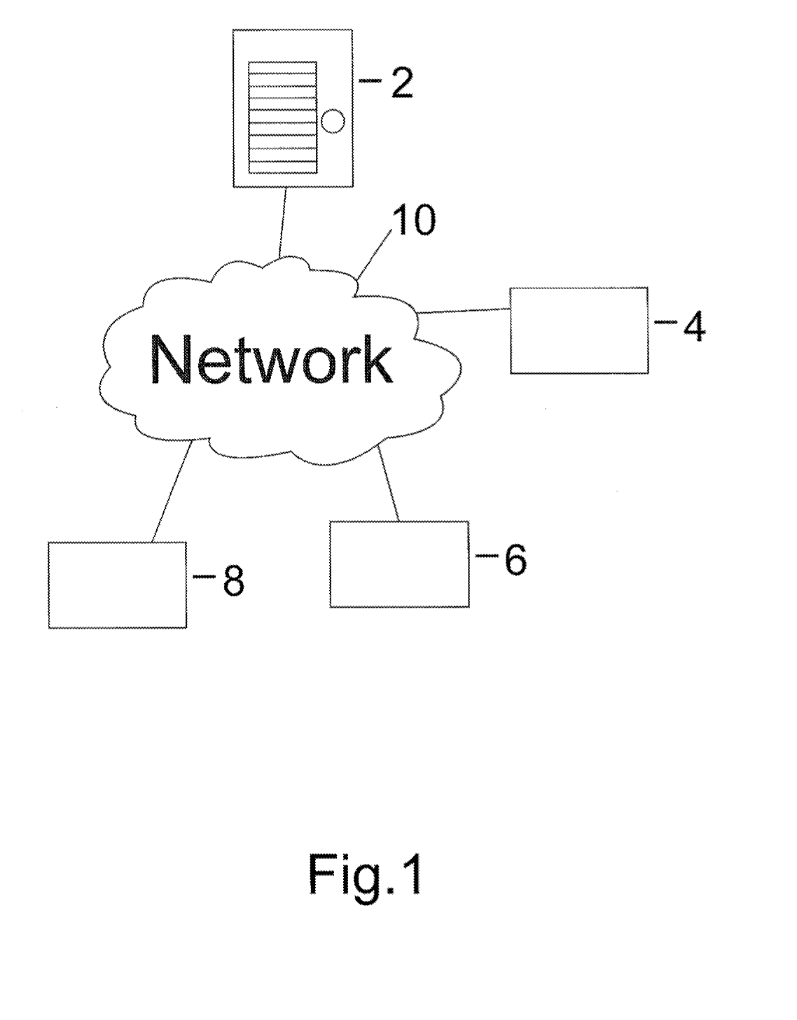

In another embodiment, as depicted in FIG. 1, a distributed computer system comprising a server computer 2 and user computers 4, 6 and 8 connectable across network 19, for example the internet, is used. Each computer system typically comprises a processor, memory, and a display, as described above.

A computer readable medium (e.g. a carrier disk or carrier signal) having computer-executable instructions adapted to cause a computer to perform the described methods may be provided.

The electronic media file can be an audio file such as a music file. It can also be a video file or other electronic media file. The electronic media file may be a digital image file, and the effects, correspondingly, may be image effects for digital images. The detailed description will focus on examples using digital image files.

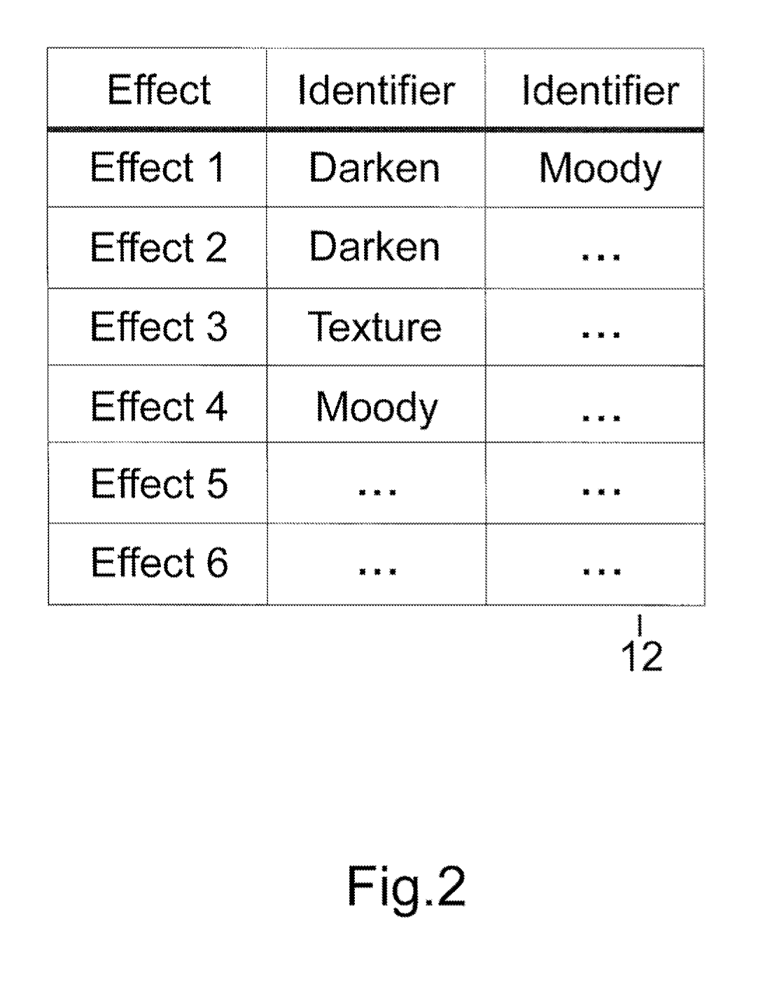

FIG. 2 illustrates a plurality of effects 12 which can be stored on the computer system as a library of effects. In one embodiment, the plurality of effects are stored on server computer 2. Each effect has one or more identifiers associated with it. For example, with reference to FIG. 2, Effect 1 has the identifiers “Darken” and “Moody” associated with it, Effect 2 has the identifier “Darken” associated with it; Effect 3 has the identifier “Texture” associated with it; and Effect 4 has the identifier “Moody” associated with it, in embodiments of the invention a large number of effects and a large number of identifiers can be stored. Effects may be associated with a large number of identifiers.

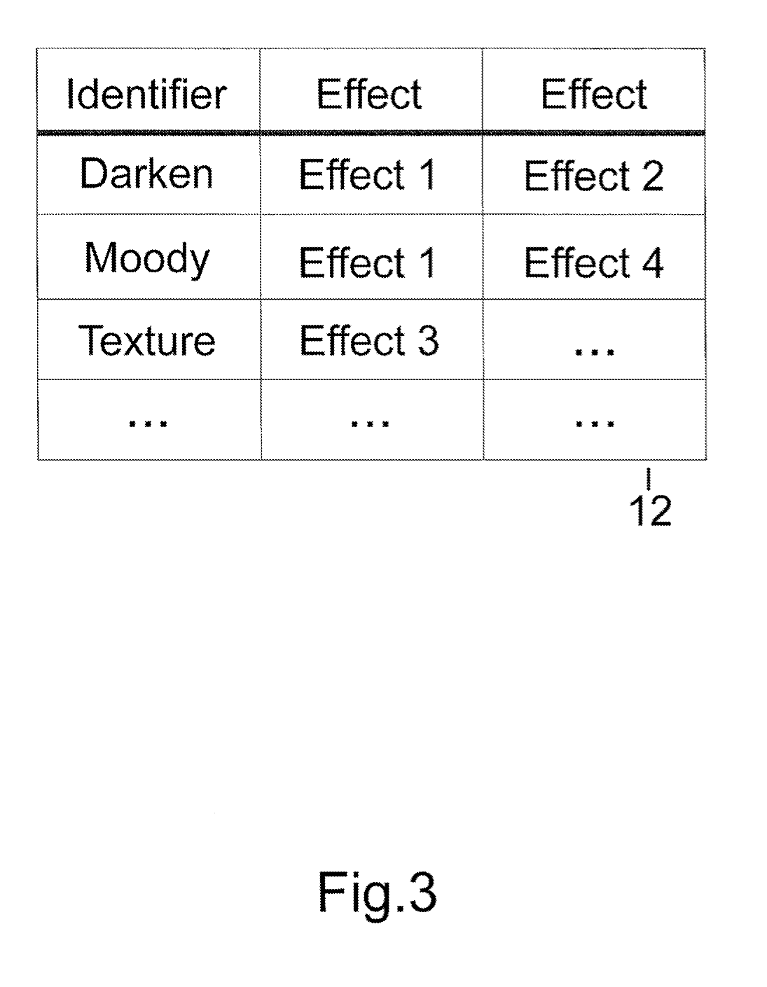

FIG. 3 shows how the same data as that of FIG. 2 can be stored by storing effects associated with identifiers.

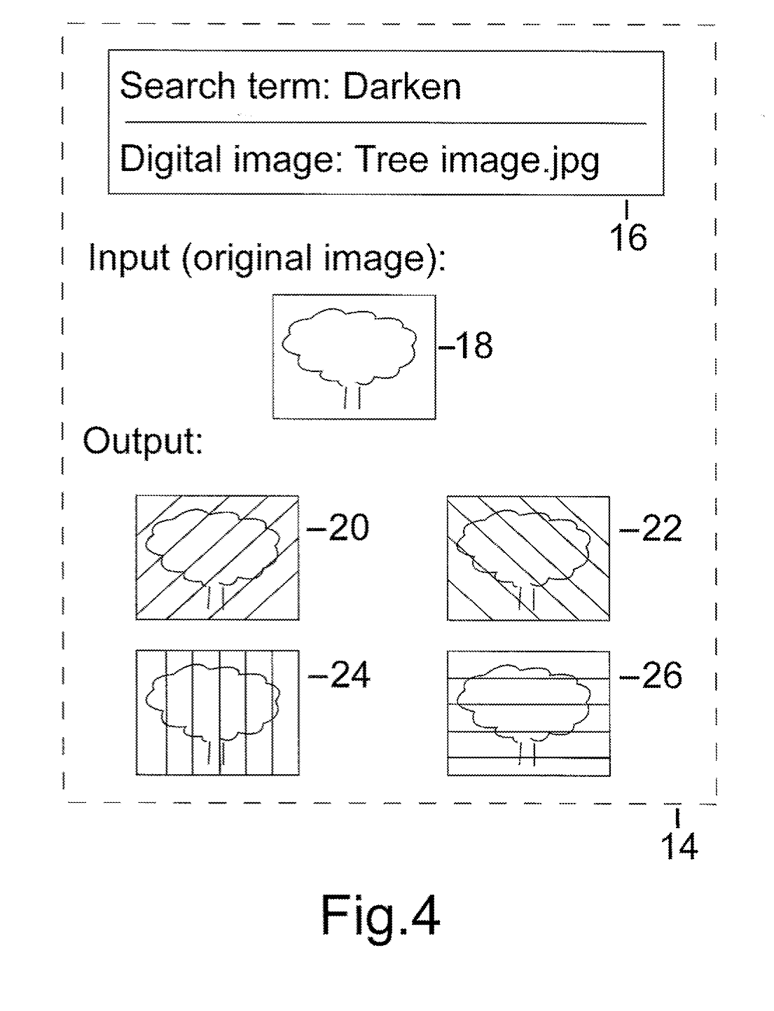

FIG. 4 illustrates how a user can use the plurality of effects 12. In one embodiment a user can use a user computer such as user computer 4, 6 or 8 to access the plurality of effects across network 10, for example by downloading a local copy of the plurality of effects 12. FIG. 4 depicts the display 4 of the user computer. The user can enter as input 16 a search term and a digital image file which in this example is “Tree image.jpg”. Based on this input a search can be performed using the identifier to retrieved effects from the plurality of effects which are associated with that identifier, such as for the “darken” identifier Effect 1 and Effect 2. Although not depicted in FIGS. 2 and 3, other Effects are associated with this identifier. An output comprising each of the effects applied to the digital image is produced. In FIG. 4, the output comprises four modified digital images, 20, 22, 24 and 26 which each correspond to a single effect from the plurality of effects which is associated with the identifier “darken”. For example, modified digital image 20 corresponds to and shows Effect 1 applied to the digital image, modified digital image 22 corresponds to and shows Effect 2 applied to the digital image and so on. In embodiments of the invention a large number of effects may be shown in the output.

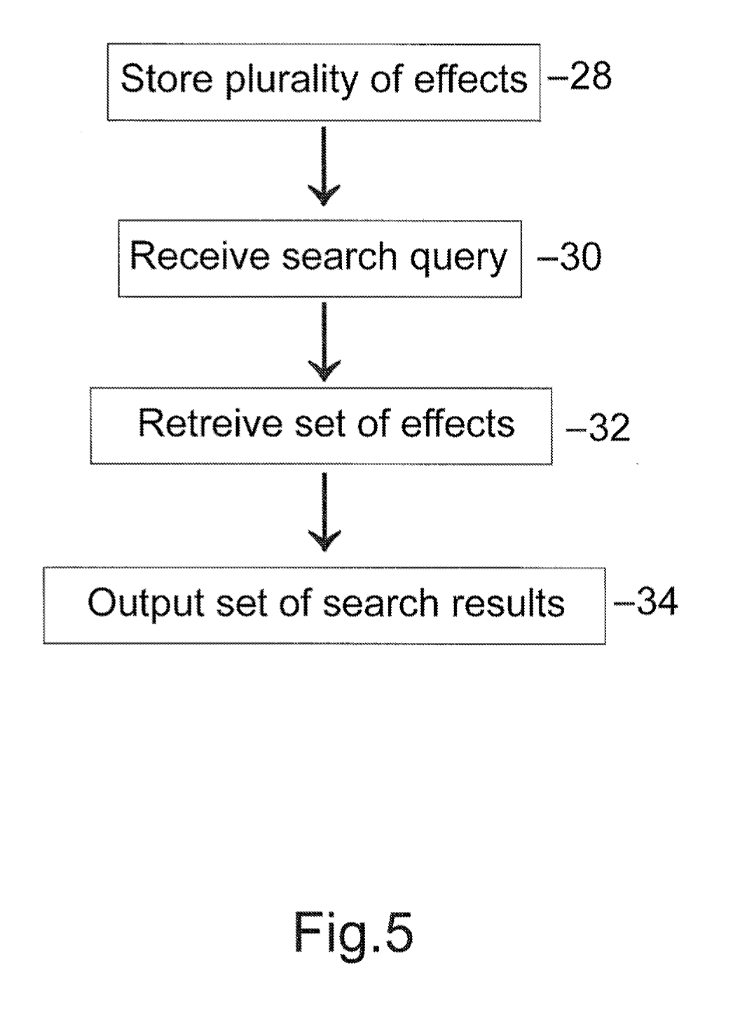

FIG. 5 illustrates a method of searching for an effect to apply to an electronic media file, in accordance with an embodiment of the present invention. The method comprises, at step 28 storing a plurality of effects (for example, as described above and illustrated with reference to FIGS. 2 and 3 above). These may be provided at the time of configuring the system. Additionally or alternatively, the effects may be provided, by users, for example by users uploading the effects to the plurality of effects stored on server computer 2 using their user computers 4, 6 and 8. At step 30, a search query is received which defines one or more search terms having one or more corresponding identifiers (for example, as described above and illustrated with reference to FIG. 4). At step 32, a set of effects which are associated with the one or more identifiers are retrieved (for example, as described above). These are applied to the inputted digital image. At step 34, a set of search results comprising the set of retrieved effects is outputted, each applied to the content of the electronic media file (here the digital image).

In some embodiments the method may also comprise receiving and storing different effects from different users, each effect having one or more identifiers associated with it. The implementation of these effects can be anything from a macro in an existing image processing package, to a network of image processing transforms, or even programmed via any suitable language. If users are creating the effects, they can upload new effects to the server along with an initial set of identifiers to associate with it. The server computer then adds this effect into the library and sets up the initial identifiers, to make it available to all the other users. In some embodiments the server can check that duplicate effects are not included.

In a particular implementation, all distances and sizes are measured as a proportion of the original image's dimensions. Otherwise, for example when using a blurring effect, if the blur radius was stored in pixels, the effect would look different depending on the image resolution.

Identifiers may be of different types. For example, one or more identifiers can be descriptive identifiers which are descriptive of the type of effect. These are possibly the most important identifiers, because they connect an intended outcome with the effect. For instance, the identifier ‘brightness’ is used to brighten an area. This is not limited to technical identifiers. For instance, ‘moody’, ‘gritty’ or ‘graphic’ could be used.

One or more identifiers can be content identifiers which are descriptive of at least part of the content of an electronic media file. Photo identifiers, for example, describe the contents of the photo. For example, ‘interior’, ‘exterior’, ‘night’, ‘waterfall’ and ‘beach’.

One or more identifiers can be setting identifiers which are indicative of at least one technical setting used to record an electronic media file. Accordingly, in addition to user specified photo identifiers, some identifiers can be added automatically from a photo and its meta-data stored in the exif block. For example the following identifiers can be automatically searched for: ‘Long exposure’: if the meta data indicates a long exposure; ‘Dark’: if the histogram for the image lies within certain bounds

In one particular implementation photo identifiers can be selected from a hierarchy, with relevant identifiers being shown under each section. For instance, water and sand are accessible directly under beach.

One or more identifiers can be object identifiers which are indicative of an object to which the effect is to be applied within an electronic media file. In a particular implementation, whenever a user selects an area, this is represented simply as the name of the area. The position of pixels covering the sky, for example, will not typically be in the same place in other images. When the effect is applied to another image, the user is asked to mark out the area of the sky in their own image using selection tools.

When applying effects to a user specified area of the photo, some effects work better on specific objects or classes of object. For instance an effect might affect the shininess of metallic objects, in which case it might be associated with the identifier “Metal”.

In some embodiments the search query defines search terms having at least three corresponding identifiers, the at least three corresponding identifiers comprising a descriptive identifier, a content identifier and an object identifier.

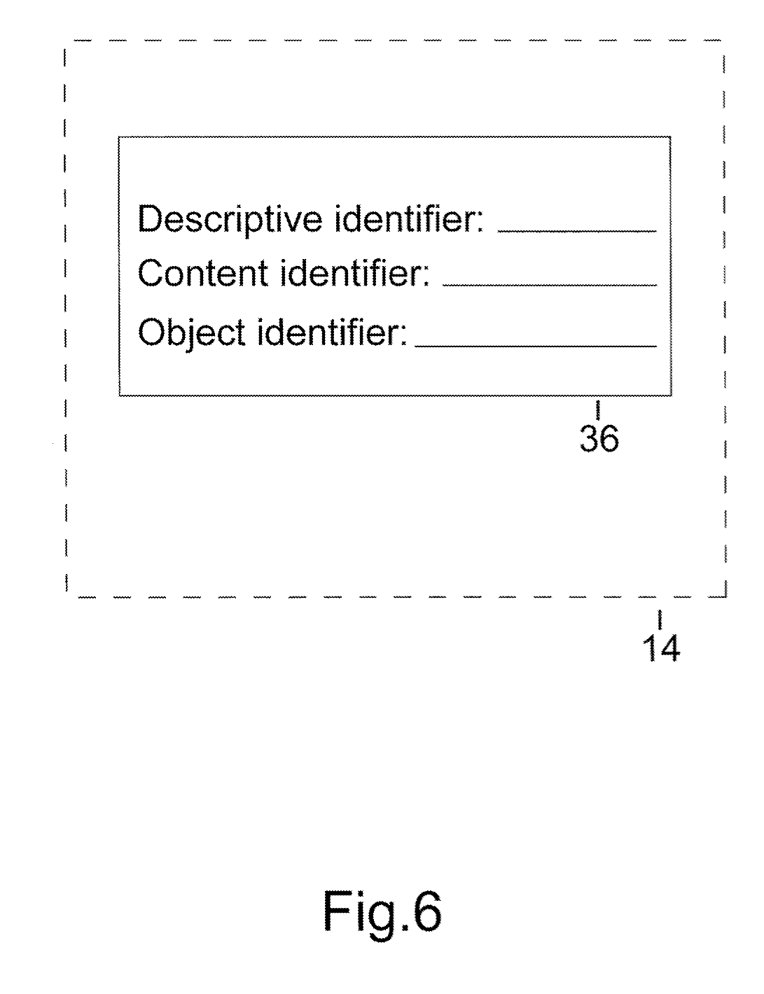

FIG. 6 illustrates the use of such a multiple search term query 36.

Combinations of identifiers can be made. The following combinations for example can be made:

Effect identifier+photo type identifier. For example, a user can chooses a ‘saturation’ effect identifier along with a ‘portrait’ photo type identifier, and a search for ‘saturation portrait’ as an identifier will be made. Once trained this may provide a strong match to effects that increase the saturation for all colours except skin tones, where increasing the saturation has a bad affect.

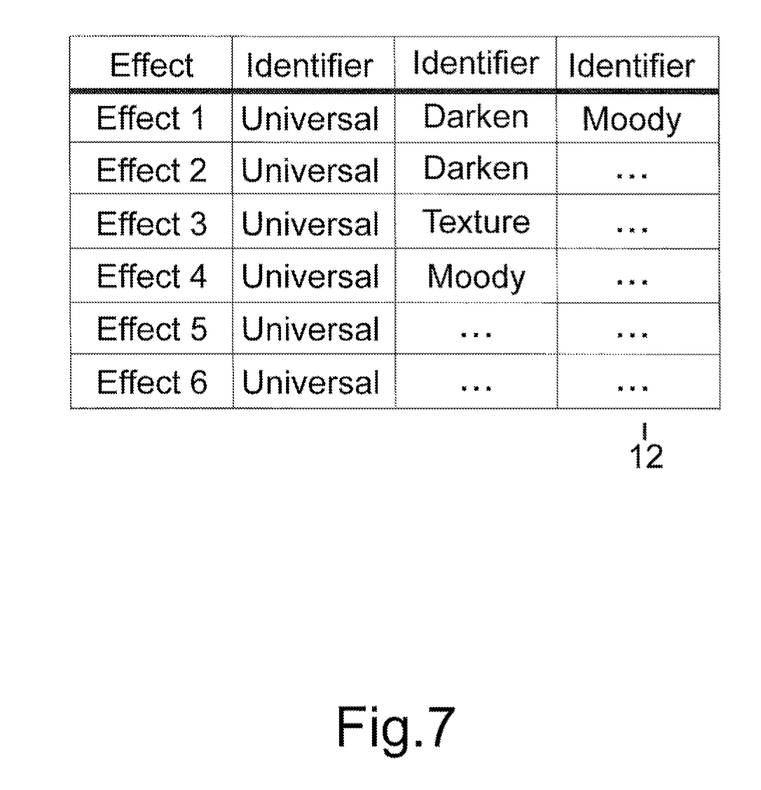

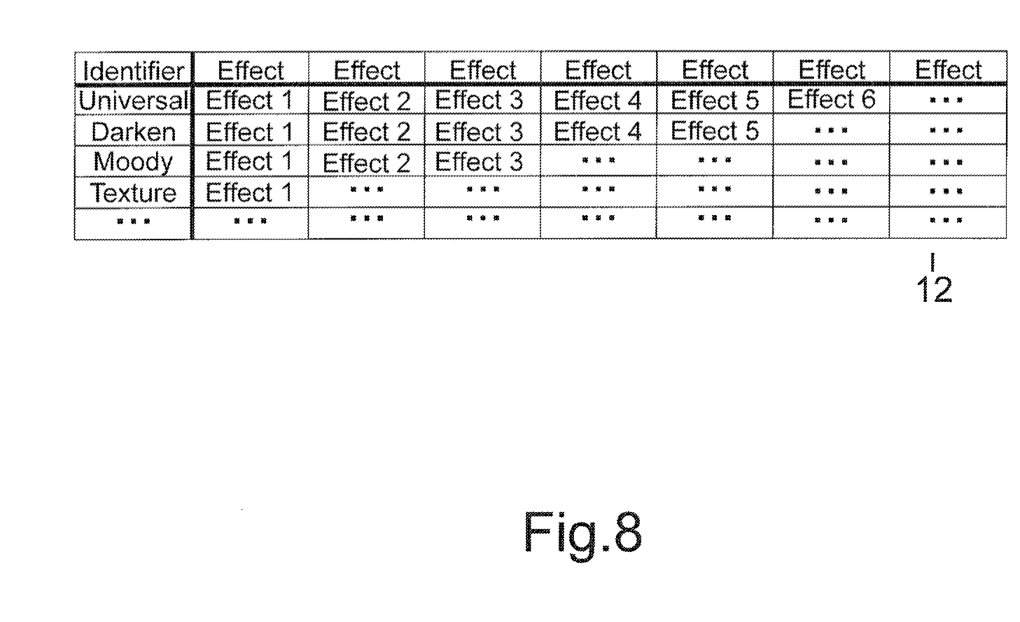

Effect identifier+object type: Similarly, object and effect identifiers can be combined together to find effects that are specifically tuned to a given object. A universal identifier which is automatically defined for a search can be included in some embodiments. The universal identifier identifies all of the plurality of effects, and can be used to ensure all effects are considered (though they would typically be scored and ordered in some way and presented accordingly). When scoring of some kind is used (described later), the universal identifier can be used to record an overall popularity score. FIGS. 7 and 8 shows how the library or plurality of effects 12 using a universal identifier are stored in some embodiments

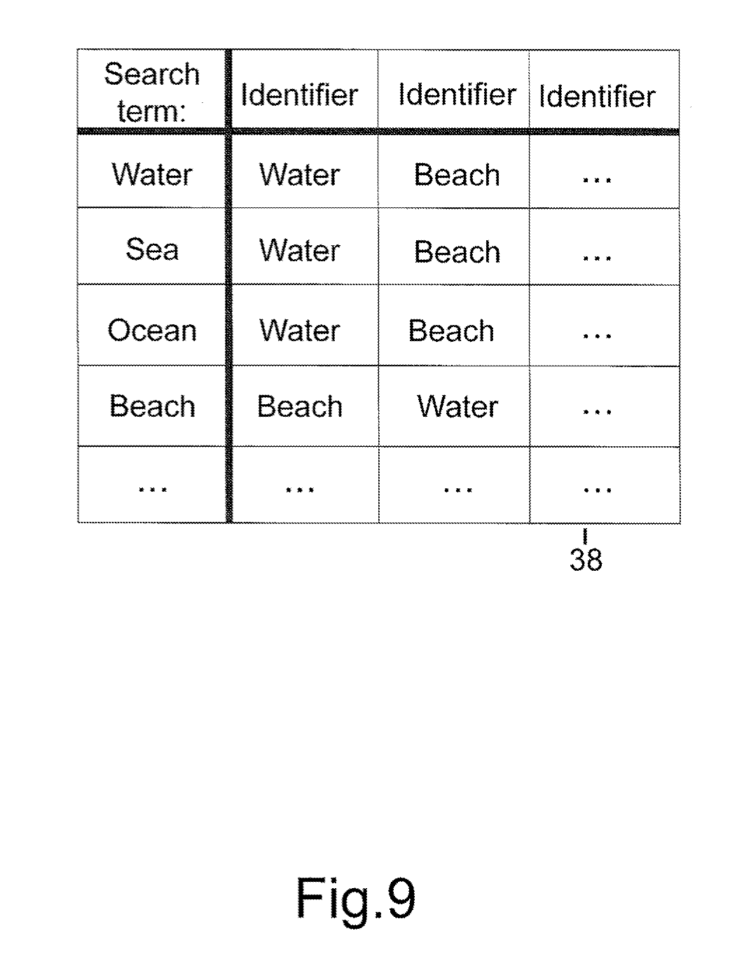

In some embodiments the method further comprises maintaining a dictionary to link search terms and identifiers; and using the dictionary to retrieve an effect associated with one or more identifiers for a search which uses a search term which is linked to the one or more identifiers in the dictionary. FIG. 9 illustrates an example of the dictionary, from which it can be seen that identifiers can be associated with other identifiers (for example, water with Beach and Beach with Water) and how non-identifier search terms such as Ocean can be associated with identifiers such as Water and Beach. Searches using search terms such as Ocean can be used to retrieve effects associated with the identifiers associated with this term, which in this example are Water and Beach.

Similarly, natural language processing can be applied to the identifiers to generalise them. For instance, a hypernym dictionary can be used. For instance, if the user has selected the ‘sea’, effects that require a ‘water’ selection can use the sea selection instead. Effects that use selections that have not been selected yet are shown on an example picture which has a given area selected. If there are several example pictures that could be used, the system can try and pick the one that is most likely to be picked given its prior performance by recording scores such as the number of times the example is shown (specifically for each effect, or generally overall), compared to how many times it was chosen.

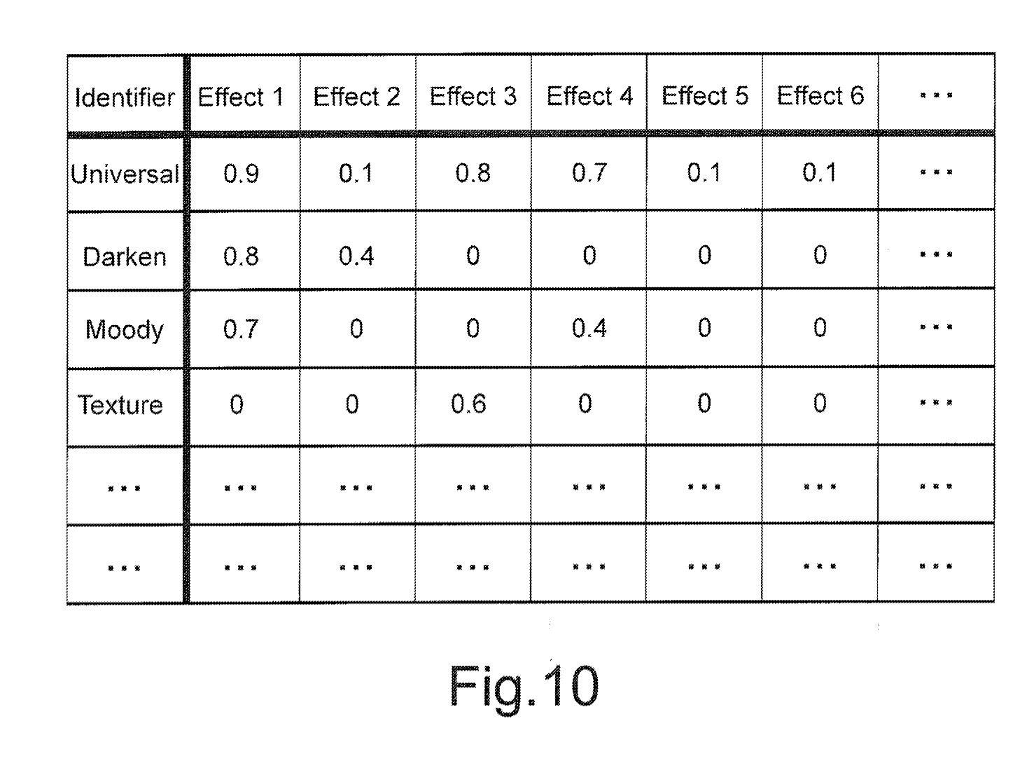

In some embodiments, the method comprises maintaining for each identifier one or more scores for each effect which is associated with the identifier, the scores being for using to order each effect relative to other effects in the set of search results. FIG. 10 illustrates how scores for each effect for each identifier can be stored. In this example a score between zero and one is maintained for each effect for each identifier. The universal identifier will always have a non-zero value in this example, and is indicative of an overall popularity. The other identifiers can have zero scores for some effects. A score nearer one is a better score than a score of or nearer zero. So, for example a search using the identifier “Darken” would result in Effect 1 being the best match with a score of 0.8 followed by Effect 2 with a score of 0.4, and the search results could be presented in the order of most popular to least popular i.e. Effect 1 then Effect 2 in this example.

In some embodiments a viewed score is maintained for each effect associated with the identifier. The viewed score is based on the number of times the effect has been shown in the sets of search results for other searches using a search term which corresponds with the identifier.

In some embodiments an approved score is maintained for each effect associated with the identifier. The approved score is based on the number of times the effect has been approved from the sets of search results for other searches using a search term which corresponds with the identifier. The approved score for an effect in some embodiments is increased in response to a user selecting an effect from the set of effects. The approved score for an effect in some embodiments is increased in response to user voting for an effect from the set of effects.

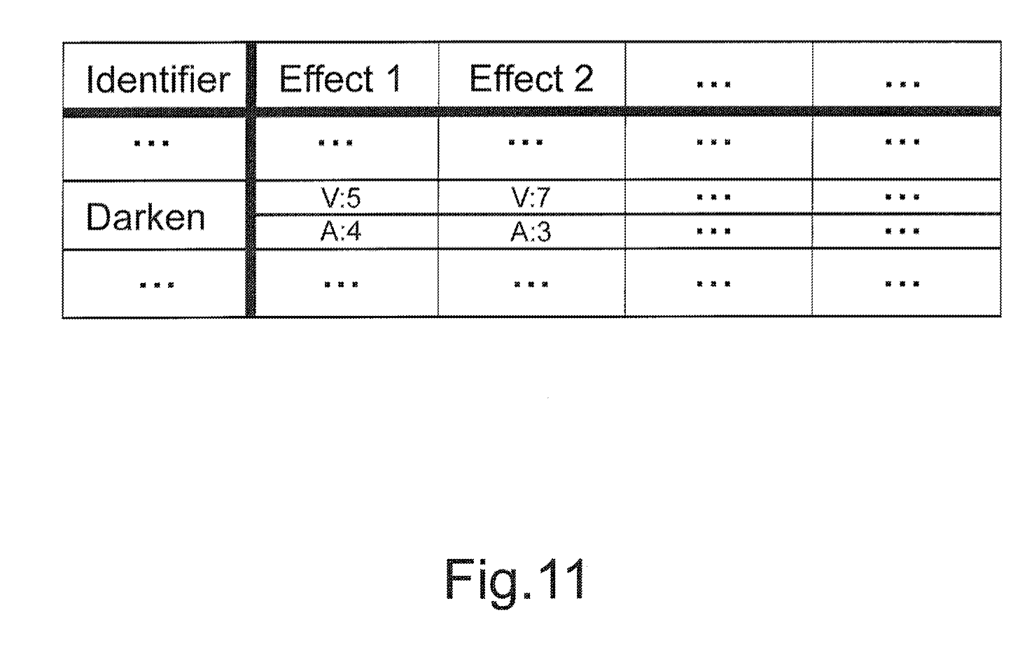

FIG. 11 illustrates how the viewed scores “V” and approved scores “A” can be stored for Effects 1 and 2 for the “Darken” identifier. Viewed scores “V” and approved scores “A” would also typically be stored for the each effect for each identifier (not depicted in the figure).

In some embodiments, the method further comprises: for each identifier which corresponds to a search term, retrieving the one or more scores associated each effect associated with the identifier and determining a weight for each effect based on the one or more scores for the identifier; for each retrieved effect combining the one or more weights determined for the effect to obtain an overall weight; and ordering the set of retrieved effects in the search results based on the overall weights of the effects.

The weight of an effect for an identifier can based on a comparison of the approved score and the viewed score, for example by dividing the approved score by the viewed score. In some embodiments the weight for an effect for an identifier if it has a low viewed score can be lowered. One equation which can be used to achieve this is:

Weight=(A+k₁)/(V+k₂)

Where A=the approved score, V=the viewed score, k₁ is a small constant and k₂ is a large constant. An overall weight for each effect is calculated based on the individual weights for all the identifiers. The effects can then be ordered by overall weight, with the effect with the highest overall weight first.

In some embodiments, when an effect is viewed and/or approved by a user, the “V” and/or “A” score respectively for that effect for the identifiers used is increased by one, which provides feedback into the scores stored in the library and increases the likelihood of effects which are considered as useful being found for future searches. Additionally or alternatively, a score can be increased by 0.5 when an effect is short-listed but not approved.

In some embodiments, a scheme for combining weights into an overall weight for an effect includes scaling each weight by a scale factor particular to the type of identifier and summing the scaled weights. This makes particular types of identifiers more or less influential. Example identifier types include: the universal identifier; descriptive identifiers; content identifiers; object identifiers; descriptive+content identifiers; and descriptive+object identifiers.

In some embodiments, for each retrieved effect the combining of the one or more weights determined for the effect to obtain an overall weight gives greater weighting to weights for effects associated with descriptive identifiers than to weights for effects associated with content identifiers.

In some embodiments, for each retrieved effect the combining of the one or more weights determined for the effect to obtain an overall weight gives lower weighting to weights for effects where the identifier is different from the search term (e.g. the dictionary of FIG. 9 is used).

In summary, as will be appreciated from the foregoing description, in various embodiments of the invention a set of stored effects or a plurality of effects can be applied to an electronic media file. Effects can be considered as procedures which can be applied to the content of electronic media files. Each effect when applied to a media file provided by a user applies an associated change to an aspect of the content of the media file. For example, for a digital image file, the effect when applied to the image provided by a user causes a particular change to a visual aspect of the image (i.e. a the effect, when applied, is a visual effect) such as to darken the appearance of the user-supplied image or to change the level of shininess of metallic objects shown within the user-supplied image. For other electronic media files such as an audio file the effect may change an audio aspect of an audio component stored in the file. Accordingly, a user can provide their own electronic media file and have a plurality of different effects or procedures automatically applied to an aspect of the content of their file. The user can then select an effect which they wish to use. This is a less complex approach of applying effects to electronic media files than was previously used.

Embodiments of the invention have been described by way of example only. It will be appreciated that variations of the described embodiments may be made which are still within the scope of the invention.

1. A method of searching for an effect to apply to an electronic media file, the method comprising:
storing a plurality of effects, each effect having one or more identifiers associated with it;
receiving a search query which defines one or more search terms having one or more corresponding identifiers;
retrieving a set of effects which are associated with the one or more identifiers; and
outputting a set of search results comprising the set of retrieved effects, each applied to the electronic media file.

2. A method according to claim 1, further comprising:
receiving and storing different effects from different users, each effect having one or more identifiers associated with it.

3. A method according to claim 1, wherein one or more identifiers are descriptive identifiers which are descriptive of the type of effect.

4. A method according to claim 1, wherein one or more identifiers are content identifiers which are descriptive of at least part of the content of an electronic media file.

5. A method according to any claim 1, wherein one or more identifiers are object identifiers which are indicative of an object to which the effect is to be applied within an electronic media file.

6. A method according to claim 5, wherein the search query which defines search terms having at least three corresponding identifiers, the at least three corresponding identifiers comprising a descriptive identifier, a content identifier and an object identifier.

7. A method according to any claim 1, wherein one or more identifiers are setting identifiers which are indicative of at least one technical setting used to record an electronic media file.

8. A method according to any claim 1, wherein an identifier is a universal identifier which is automatically defined for a search, wherein the universal identifier identifies all of the plurality of effects.

9. A method according to claim 1, further comprising:
maintaining a dictionary to link search terms and identifiers; and
using the dictionary to retrieve an effect associated with one or more identifiers for a search which uses a search term which is linked to the one or more identifiers in the dictionary.

10. A method according to any claim 1, the method comprising:
maintaining for each identifier one or more scores for each effect which is associated with the identifier, the scores being for using to order each effect relative to other effects in the set of search results.

11. A method according to claim 10, wherein a viewed score is maintained for each effect associated with the identifier, wherein the viewed score is based on the number of times the effect has been shown in the sets of search results for other searches using a search term which corresponds with the identifier.

12. A method according to claim 10, wherein an approved score is maintained for each effect associated with the identifier, wherein the approved score is based on the number of times the effect has been approved from the sets of search results for other searches using a search term which corresponds with the identifier.

13. A method according to claim 12, wherein the approved score for an effect is increased in response to a user selecting an effect from the set of effects.

14. A method according to claim 12, wherein the approved score for an effect is increased in response to user voting for an effect from the set of effects.

15. A method according to claim 10, the method further comprising:
for each identifier which corresponds to a search term, retrieving the one or more scores associated each effect associated with the identifier and determining a weight for each effect based on the one or more scores for the identifier;
for each retrieved effect combining the one or more weights determined for the effect to obtain an overall weight; and
ordering the set of retrieved effects in the search results based on the overall weights of the effects.

16. A method according to claim 15, wherein the weight for an effect is based on a comparison of the approved score and the viewed score.

17. A method according to claim 16, wherein the weight for an effect is based on dividing the approved score by the viewed score.

18. A method according to claim 16, comprising lowering the weight for an effect if effect has a low viewed score.

19. A method according to any claim 15, wherein for each retrieved effect the combining of the one or more weights determined for the effect to obtain an overall weight gives greater weighting to weights for effects associated with descriptive identifiers than to weights for effects associated with content identifiers.

20. A method according to claim 13, wherein for each retrieved effect the combining of the one or more weights determined for the effect to obtain an overall weight gives lower weighting to weights for effects where the identifier is different from the search term.

21. A method according to claim 1, wherein the electronic media file is a digital image file, and wherein the effects are image effects for digital images.

22. A computer comprising a memory and a processor, wherein the processor is adapted to perform the method of claim 1.

23. A computer readable medium having computer-executable instructions adapted to cause a computer to perform a method of claim 1.
